(19) United States
(12) Patent Application Publication
(10) Pub. No.: US 2025/0215214 A1
(43) Pub. Date: Jul. 3, 2025

(54) POLYLACTIDE RESIN COMPOSITION, AND METHOD FOR PREPARING THE SAME

(71) Applicant: LG CHEM, LTD., Seoul (KR)

(72) Inventors: Yeonji Choe, Daejeon (KR); Jeongkyu Lee, Daejeon (KR); Jeong Hun Cho, Daejeon (KR); Yujin An, Daejeon (KR); Sung Joon Oh, Daejeon (KR); Wan Kyu Oh, Daejeon (KR)

(21) Appl. No.: 18/704,028

(22) PCT Filed: Mar. 15, 2023
(86) PCT No.: PCT/KR2023/003453

§ 371 Date: Apr. 23, 2024

(30) Foreign Application Priority Data
Mar. 22, 2022 (KR) 10-2022-0035551

(51) Int. Cl. C08L 67/04; C08K 5/3462

(52) U.S. Cl. CPC C08L 67/04; C08K 5/3462

(57) ABSTRACT

A polylactide resin composition used in combination with a specific nucleating agent, which can relatively increase the mobility of high molecular weight of the polylactide resin to improve the crystallinity degree, and at the same time, causes an amorphous region of the polylactide resin to have a low glass transition, thereby lowering the glass transition temperature of the polylactide resin composition, and simultaneously improving the crystallinity degree thereof.

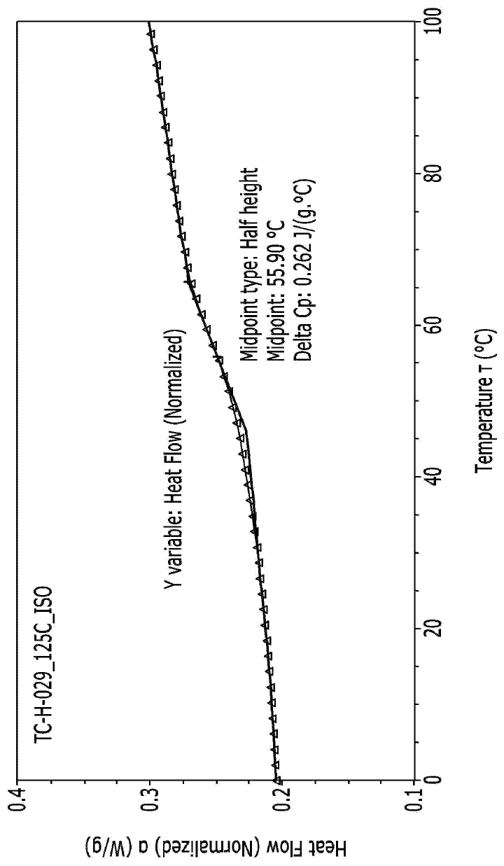

### CROSS-REFERENCE TO RELATED APPLICATION(S)

This application is a National Stage Application of International Application No. PCT/KR2023/003453 filed on Mar. 15, 2023, which claims the benefit of Korean Patent Application No. 10-2022-0035551 filed on Mar. 22, 2022 with the Korean Intellectual Property Office, the disclosure of which is incorporated herein by reference in its entirety.

### TECHNICAL FIELD

The present invention relates to a polylactide resin composition having a low glass transition temperature and an excellent crystallinity degree, and a method for preparing the same.

### BACKGROUND

Polylactide (or polylactic acid; PLA) resin is prepared based on biomass materials, and is an eco-friendly material which emits less global warming gas carbon dioxide during the production process, and is degraded by a specific temperature and composting facility. In recent years, it has also attracted attention as one of the materials that can replace existing crude oil-based resins as a measure for the upcycling of waste plastics and regulation on carbon emissions.

In addition, the polylactide resin has the advantages of being inexpensive compared to other biodegradable polymers and having high tensile strength and modulus properties.

However, the polylactide resin has a problem that a rigid polymer main chain is repeated in short units, the crystallization rate is slow due to slow chain mobility, and the molding cycle is long, thereby lowering the productivity. Therefore, in order to improve these problems, many studies are being conducted to introduce a material such as a nucleating agent to improve productivity and heat resistance. In addition, the polylactide resin has brittle properties, and in order to improve this, the T_{g} (glass transition temperature) of the polylactide resin should be lowered.

Therefore, a method for increasing the crystallinity degree of the polylactide resin and simultaneously lowering the glass transition temperature is required, but general nucleating agents increase the entire chain mobility of the polylactide resin, and thus, there is a limit to improving the above two properties at the same time.

Thus, in order to improve the above properties at the same time, the present inventors have found a method of improving the crystallinity degree by relatively increasing only the mobility of high molecular weight of the polylactide resin as described later, and at the same time, making an amorphous region of the polylactide resin have a low glass transition temperature, and completed the present disclosure.

### DETAILED DESCRIPTION OF THE INVENTION

### Technical Problem

It is an object of the present disclosure to provide a polylactide resin composition having a low glass transition temperature and an excellent crystallinity degree, and a method for preparing the same.

### Technical Solution

In order to achieve the above object, according to the present disclosure, provided is the following polylactide resin composition.

A polylactide resin composition comprising:
a polylactide resin; a first nucleating agent; and a second nucleating agent,
wherein the polylactide resin composition has a glass transition temperature (T_{g,T}) and a crystallinity degree of 60° C. or less and 55% or more, respectively, which are measured by setting a crystallization temperature to a specific temperature (T) of 100 to 130° C., and
   wherein ΔT_{g} in the following Equation 1 is 5 or more:

$$Δ {T}_{g} = \vert \frac{( {T}_{g , T} - {T}_{g , 90} )}{{T}_{g , 90}} \times 100 \vert \qquad [ Equation 1 ]$$

wherein in Equation 1,
T_{g,T} is the glass transition temperature (° C.) measured by setting the crystallization temperature to the specific temperature (T) for the polylactide resin composition, and
T_{g,90} is the glass transition temperature (° C.) measured by setting the crystallization temperature to 90° C. for the polylactide resin composition.

As used herein, the term “polylactide resin” is defined as comprehensively referring to a homopolymer or copolymer including a repeating unit represented by the following Chemical Formula:

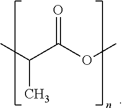

The polylactide resin can be prepared by a process including a step of forming the above repeating unit by the ring opening polymerization of the lactide monomer. The polymer obtained after the completion of such ring opening polymerization and the formation of the repeating unit can be referred to as the “polylactide resin”.

At this time, the term “lactide monomer” can be defined as follows. Typically, lactides can be classified into L-lactide consisting of L-lactic acid, D-lactide consisting of D-lactic acid, and meso-lactide consisting of an L-type and a D-type. Also, a mixture of L-lactide and D-lactide in a ratio of 50:50 is referred to as D,L-lactide or rac-lactide. Among these lactides, the polymerization proceeding only with either of L-lactide and D-lactide that have a high level of optical purity is known to yield an L- or D-polylactide (PLLA or PDLA) with a high level of stereoregularity. Such polylactides have a faster crystallization rate and also a higher crystallinity degree than a polylactide having a low level of optical purity. However, the term “lactide monomer” as used herein is defined to include all types of lactides regardless of the characteristic differences of lactides depending on their shapes and the characteristic differences of the polylactide resins obtained therefrom.

Meanwhile, the polylactide resin composition according to the present disclosure has a weight average molecular weight of 70,000 to 400,000 as an example.

The present disclosure is characterized in that the polylactide resin is used in combination of the first nucleating agent and the second nucleating agent to thereby lower the glass transition temperature of the polylactide resin and improve the crystallinity degree thereof.

The first nucleating agent is uracil or orotic acid. The first nucleating agent is a bio-based organic material, and is added to the polylactide resin, acts as a nucleation site and induces the crystal nucleus generation at high temperature, thereby being capable of improving the crystallinity degree.

Preferably, the first nucleating agent is included in an amount of 0.1 to 5% by weight based on the total weight of the polylactide resin composition. If the content is less than 0.1% by weight, the effect due to the use of the first nucleating agent is insignificant, and if the content exceeds 5% by weight, there is a risk of impairing physical properties inherent in the polylactide resin. More preferably, the first nucleating agent is included in an amount of 0.2% by weight or more, 0.3% by weight or more, 0.4% by weight or more, or 0.5% by weight or more; and 4.5% by weight or less, 4.0% by weight or less, or 3.5% by weight or less.

The second nucleating agent is a nucleating agent containing an oligomer structure of the lactide monomer. Due to the oligomer structure of the lactide monomer, it has high compatibility with the polylactide resin, and is added to the polylactide resin to play a role similar to that of a plasticizer. Thereby, a free volume can be formed in the polylactide resin to thereby enhance the chain mobility of the polylactide resin and increase the crystallinity degree. In addition, since the mobility of the high molecular weight of the polylactide resin is relatively increased, it is possible to increase the crystallinity degree of the polylactide resin and at the same time, make an amorphous region of the polylactide resin have a low glass transition temperature, thereby lowering the glass transition temperature.

Preferably, the second nucleating agent is a compound represented by the following Chemical Formula 1:

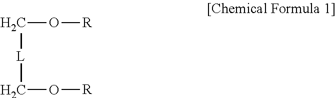

wherein in Chemical Formula 1,
L is any one selected from the group consisting of:

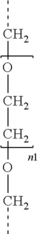

wherein,
n1 is an integer of 1 to 30, and
R is a substituent represented by the following Chemical Formula 2,

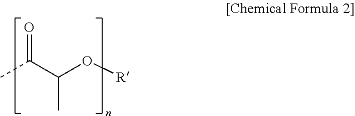

wherein:
n represents the number of repeating units, and
R′ is hydrogen or acetyl.

The weight average molecular weight of the second nucleating agent may be adjusted according to the number of each lactide repeating unit. Preferably, the weight average molecular weight of the second nucleating agent is 1,000 to 50,000. More preferably, the weight average molecular weight of the second nucleating agent is 1,100 or more, 1,200 or more, 1,300 or more, 1,400 or more, or 1,500 or more; and 40,000 or less, 30,000 or less, 20,000 or less, 10,000 or less, 9,000 or less, or 8,000 or less.

Preferably, the second nucleating agent is included in an amount of 3 to 25% by weight based on the total weight of the polylactide resin composition. If the content is less than 3% by weight, the effect due to the use of the second nucleating agent is insignificant, and if the content exceeds 25% by weight, there is a risk of impairing the physical properties inherent in the polylactide resin. More preferably, the second nucleating agent is included in an amount of 3.5% by weight or more, 4.0% by weight or more, or 4.5% by weight or more; and 24% by weight or less, 23% by weight or less, 22% or less, or 21% by weight or less.

In particular, the polylactide resin composition is characterized by having a glass transition temperature (T_{g,T}) and a crystallinity degree of 60° C. or less and 55% or more, respectively, which are measured by setting a crystallization temperature to a specific temperature (T) of 100 to 130° C.

The term “crystallization temperature” as used herein refers to the temperature when the polylactide resin composition is melted to a given temperature and then cooled to measure a glass transition temperature. Specifically, when the polylactide resin composition is melted at 200° C. and then cooled to 120° C. at a cooling rate of 40° C./min, the 120° C. is referred to as the “crystallization temperature”. Then, after maintaining an isothermal state at the above crystallization temperature for 60 minutes, it is cooled to −50° C. at a cooling rate of 40° C./min, and the temperature is raised to 200° C. at an isothermal rate of 10° C./min to measure the 2nd heating thermogram, and the half-height type in the 2nd heating thermogram is defined as the glass transition temperature (T_{g,T}). Specifically, the FIGURE is a 2nd heating thermogram of Example 5 described later. As shown in the FIGURE, since the Cₚ (heat capacity) of polylactide changes during the glass transition process, the baseline is shifted and observed. At this time, the temperature at half-height of the two baselines is defined as the glass transition temperature. In addition, the crystallinity degree (%) is also calculated from the endothermic peak area in the 2nd heating thermogram. Specific methods for measuring the glass transition temperature and crystallinity degree can be embodied in the Examples provided hereinafter.

Preferably, the polylactide resin composition has a glass transition temperature (T_{g,T}) of 56° C. or less, as measured by setting the crystallization temperature to a specific temperature (T) of 120 to 130° C. That is, the polylactide resin composition according to the present disclosure is affected by the crystallization temperature, and has a characteristic that when the crystallization temperature is set to 120 to 130° C., the glass transition temperature (T_{g,T}) is further lowered. More preferably, the polylactide resin composition has a glass transition temperature (T_{g,T}) of 50° C. or less, as measured by setting the crystallization temperature to a specific temperature (T) of 120 to 130° C. Meanwhile, the lower limit of the glass transition temperature (T_{g,T}) is, for example, 40° C. or more, 41° C. or more, 42° C. or more, 43° C. or more, 44° C. or more, or 45° C. or more.

In addition, the polylactide resin composition has ΔT_{g} of 5 or more in Equation 1. Equation 1 means the extent to which the glass transition temperature of the polylactide resin composition according to the present disclosure measured by setting the crystallization temperature to the specific temperature (T) is lowered as compared to the glass transition temperature measured by setting the crystallization temperature to 90° C., which means that as the value is higher, the glass transition temperature is lower. Preferably, ΔT_{g} in Equation 1 is 5.5 or more, 6.0 or more, or 6.5 or more. Further, preferably, ΔT_{g} in Equation 1 is 15 or less, 14 or less, 13 or less, 12 or less, or 11 or less.

Meanwhile, the method for preparing the above-mentioned polylactide resin composition according to the present disclosure is not particularly limited as long as it is a method of mixing the polylactide resin, the first nucleating agent, and the second nucleating agent. In one example, the respective components can be prepared by a melt blending method.

### Advantageous Effects

The above-mentioned polylactide resin composition according to the present disclosure has a low glass transition temperature and an excellent crystallinity degree, and thus can improve the processability of the polylactide resin composition.

### BRIEF DESCRIPTION OF THE DRAWINGS

The FIGURE shows a method for measuring the glass transition temperature in the present disclosure.

### EXAMPLES

Below, embodiments of the present disclosure will be described in more detail with reference to examples. However, the following examples are for illustrative purposes only and are not intended to limit the scope of the present disclosure.

### Preparation Example 1: Preparation of Second Nucleating Agent (P10-A-002)

An oligomer was prepared using PEG-1000 (P10) as an initiator. Specifically, lactide and P10 were added in a 20 mL vial at a molar ratio of 8:1 so that the total was 4.5 g, and Sn(Oct)₂ catalyst was added in amount to be 0.1 to 0.2 wt. %, and then reacted at 130° C. for 4 hours. After adjusting the temperature to 120° C., acetic anhydride (4 equivalents relative to the terminal OH group) was added, and further reacted for 12 hours. After completion of the reaction, byproduct acetic acid and residual acetic anhydride were removed by vacuum drying to prepare a second nucleating agent having a structure in which the terminal group was substituted with an acetyl group, which was named P10-A-002, and the weight average molecular weights are shown in Table 1 below.

### Example and Comparative Example

65 g of PLA pellet (4032D from NatureWorks; weight average molecular weight of about 200,000) and the first nucleating agent shown in Table 1 below was mixed according to the respective amounts. The mixture was placed in a Haake mixer, and mixed at 180° C. for 5 minutes at 60 rpm. The second nucleating agent shown in Table 1 below was added thereto according to the respective amounts, and mixed at 180° C. for 5 minutes at 60 rpm. At this time, in Table 1 below, the amount of the first nucleating agent and the second nucleating agent means wt. % relative to the total amount of the PLA resin, the first nucleating agent and the second nucleating agent.

### Experimental Example

The physical properties of the polylactide resin composition prepared above were measured by the following methods.

### 1) Weight Average Molecular Weight

For the previously prepared second nucleating agent, the number average molecular weight (Mn) and the weight average molecular weight (Mw) were calculated using a GPC (Gel Permeation Chromatography) device, and the oligomer molecular weight distribution (Mw/Mn) was measured, and specific measurement conditions are as follows.
Column: PLgel Mixed E×2
Solvent: THF
Flow rate: 0.7 mL/min
Sample concentration: 3.0 mg/mL
Injection volume: 100 μl
Column temperature: 40° C.
Detector: Waters 2414 RID
Standard: PS (Polystyrene)

### 2) DSC (Differential Scanning Calorimetry)

Each of the polylactide resin compositions prepared in Examples and Comparative Examples was completely melted at 200° C. for 20 minutes in order to eliminate the thermal history. Then, it was cooled at a cooling rate of 40° C./min to the crystallization temperature shown in Table 1 below. After maintaining an isothermal state at the above crystallization temperature for 60 minutes, it was cooled to −50° C. at a cooling rate of 40° C./min. Again, the temperature was raised to 200° C. at a heating rate of 10° C./min, and a 2nd heating thermogram was observed. At this time, T_{g,T} was defined as a half-height type, and the crystallinity degree (%) was calculated using the following Equation (100% crystalline PLA ΔHm=93 J/g). w refers to the nucleating agent content (for example, in the case of 5 wt. %, w is 0.05).
Crystallinity degree: ((Endothermic peak area in 2nd thermogram, ΔHm-cold crystallization exothermic peak area, ΔHcc)/(1−w)*(100% crystalline PLA ΔHm))*100

Further, the same process as above was performed, but the crystallization temperature was set to 90° C., and T_{g,90} was measured, and then ΔT_{g} of Equation 1 was calculated.

$$Δ {T}_{g} = \vert \frac{( {T}_{g , T} - {T}_{g , 90} )}{{T}_{g , 90}} \times 100 \vert \qquad [ Equation 1 ]$$

in Equation 1,
T_{g,T} is the glass transition temperature (° C.) measured by setting the crystallization temperature to a specific temperature (T) for the polylactide resin composition, and
T_{g,90} is the glass transition temperature (° C.) measured by setting the crystallization temperature to 90° C. for the polylactide resin composition.

The results are shown in Table 1 below.

TABLE 1

| | | First | Second | | | | |
|---|---|---|---|---|---|---|---|
| | First | nucleating | nucleating agent | Crystallization | | Crystallinity | |
| | nucleating | agent content | content (Mw: | temperature | T_{g, T} | degree | |
| | agent | (wt. %) | 6000) (wt. %) | (T) (° C.) | (° C.) | (%) | ΔT_{g} |
| Example 1 | orotic acid | 3 | 5 | 120 | 55 | 55 | 5.7 |
| Example 2 | orotic acid | 3 | 5 | 130 | 54 | 58 | 6.7 |
| Example 3 | orotic acid | 3 | 10 | 120 | 48 | 57 | 6.5 |
| Example 4 | orotic acid | 3 | 10 | 130 | 47 | 62 | 7.2 |
| Example 5 | uracil | 3 | 5 | 125 | 56 | 56 | 6.8 |
| Example 6 | uracil | 3 | 10 | 125 | 49 | 59 | 11.4 |
| Example 7 | uracil | 1 | 10 | 120 | 50 | 57 | 7.1 |
| Example 8 | uracil | 1 | 10 | 125 | 50 | 58 | 6.4 |
| Example 9 | uracil | 1 | 10 | 130 | 48 | 63 | 10.3 |
| Comparative | orotic acid | 1 | 0 | 120 | 63 | 52 | 3.8 |
| Example 1 | | | | | | | |
| Comparative | orotic acid | 1 | 0 | 130 | 63 | 57 | 5.0 |
| Example 2 | | | | | | | |
| Comparative | orotic acid | 3 | 0 | 130 | 62 | 55 | 4.3 |
| Example 3 | | | | | | | |
| Comparative | orotic acid | 3 | 0 | 120 | 63 | 52 | 2.8 |
| Example 4 | | | | | | | |
| Comparative | orotic acid | 3 | 0 | 110 | 63 | 47 | 1.7 |
| Example 5 | | | | | | | |
| Comparative | uracil | 1 | 0 | 120 | 64 | 50 | 1.4 |
| Example 6 | | | | | | | |
| Comparative | uracil | 1 | 0 | 130 | 63 | 55 | 3.1 |
| Example 7 | | | | | | | |
| Comparative | uracil | 3 | 0 | 120 | 63 | 50 | 2.9 |
| Example 8 | | | | | | | |
| Comparative | uracil | 3 | 0 | 130 | 62 | 56 | 4.3 |
| Example 9 | | | | | | | |

As shown in Table 1, it was confirmed that in the case of Examples in which the first nucleating agent and the second nucleating agent were used simultaneously according to the present disclosure, the glass transition temperature can be lowered and the crystallinity degree is improved as compared to the Comparative Examples.

1. A polylactide resin composition, comprising:
a polylactide resin; a first nucleating agent; and a second nucleating agent,
wherein the polylactide resin composition has a glass transition temperature (T_{g,T}) and a crystallinity degree of 60° C. or less and 55% or more, respectively, which are measured by setting a crystallization temperature to a specific temperature (T) of 100 to 130° C., and
wherein ΔT_{g} in the following Equation 1 is 5 or more:
$$Δ {T}_{g} = \vert \frac{( {T}_{g , T} - {T}_{g , 90} )}{{T}_{g , 90}} \times 100 \vert \qquad [ Equation 1 ]$$
wherein in Equation 1,
T_{g,T} is the glass transition temperature (° C.) measured by setting the crystallization temperature to the specific temperature (T) for the polylactide resin composition, and
T_{g,90} is the glass transition temperature (° C.) measured by setting the crystallization temperature to 90° C. for the polylactide resin composition.

2. The polylactide resin composition of claim 1,
wherein the first nucleating agent is uracil or orotic acid.

3. The polylactide resin composition of claim 1,
wherein the first nucleating agent is included in an amount of 0.1 to 5% by weight based on the total weight of the polylactide resin composition.

4. The polylactide resin composition of claim 1,
wherein the second nucleating agent is a compound containing a lactide oligomer structure.

5. The polylactide resin composition of claim 1,
wherein the second nucleating agent is included in an amount of 3 to 25% by weight based on the total weight of the polylactide resin composition.

6. The polylactide resin composition of claim 1,
wherein the polylactide resin composition has a glass transition temperature (T_{g,T}) of 56° C. or less, as measured by setting the crystallization temperature to a specific temperature (T) of 120 to 130° C.

7. The polylactide resin composition of claim 1,
wherein the polylactide resin composition has a glass transition temperature (T_{g,T}) of 50° C. or less, as measured by setting the crystallization temperature to a specific temperature (T) of 120 to 130° C.

8. The polylactide resin composition of claim 7,
wherein ΔT_{g} in Equation 1 is 6.5 or more.

9. The polylactide resin composition of claim 1,
wherein the polylactide resin composition has a weight average molecular weight of 70,000 to 400,000.
